(19) United States
(12) Patent Application Publication
(10) Pub. No.: US 2013/0297620 A1
(43) Pub. Date: Nov. 7, 2013

(54) System and Method for Evaluating Scholarly Productivity

(71) Applicants: David Metro, Gibsonia, PA (US); Tetsuro Sakai, Pittsburgh, PA (US); Trent Emerick, Cranberry Township, PA (US)

(72) Inventors: David Metro, Gibsonia, PA (US); Tetsuro Sakai, Pittsburgh, PA (US); Trent Emerick, Cranberry Township, PA (US)

(21) Appl. No.: 13/888,898

(22) Filed: May 7, 2013

Related U.S. Application Data
(60) Provisional application No. 61/643,554, filed on May 7, 2012.

(51) Int. Cl. G06F 17/30

(52) U.S. Cl. CPC G06F 17/3053
USPC 707/748

(57) ABSTRACT

The present invention is directed to a method whereby scholarly activities of graduate students, including medical school residents, can be objectively evaluated. Using the present invention, research activities can be converted into scholarly activity points that are then weighted to reflect the degree of challenge and investment in the scholarly activity. A website interface is utilized by participants to enter scholarly activities. This data can be used and manipulated for multiple purposes, not limited to ratings, rankings, and comparisons.

### CROSS-REFERENCE TO RELATED APPLICATION

This application claims the benefit of U.S. Provisional Application No. 61/643,554 filed on May 7, 2012, which is hereby incorporated by reference in its entirety.

### BACKGROUND OF THE INVENTION

1. Field of the Invention

The present invention is directed to the provision of a method whereby scholarly activities of graduate students, including medical school residents, can be objectively evaluated. The method is centered upon the use of what will be referred to as the Scholarly Activity Point (“SAP”) system. The SAP and website interface is used to more accurately and objectively evaluate research productivity. Using the methodology of the SAP, research activities can be converted into scholarly activity points. SAPs are weighted to reflect the degree of challenge and investment in the scholarly activity. The website interface is utilized by participants to enter scholarly activities. The system then calculates SAPs and saves SAP data. This data can be used and manipulated for multiple purposes, not limited to ratings, rankings, and comparisons.

This SAP methodology and website were initially created out of the need for a more objective tool to evaluate scholarly productivity within an anesthesiology medical residency program in Pittsburgh, Pa. By way of example, we will focus on the scholarly activity of medical residents, although this system could apply to (and is intended to apply to) anyone pursuing academic or scholarly work. Academic or scholarly activities includes without limitation the authorship of abstracts presented at local and national conferences, manuscripts, book chapters, grant applications, leadership positions, educational activities, and political activism. The target audience of the SAP method and website includes both those that complete scholarly activities (including graduate students, medical students/residents/fellows, academic faculty) and those that would need to evaluate scholarly productivity (academic chair, program director, supervisor, or manager, admissions, employers, for example). It could further include book and magazine publishers and the like that attempt to rank academic institutions and departments.

### BRIEF DESCRIPTION OF THE DRAWING(S)

FIG. 1 is a chart showing the scholarly activity points by graduating class of anesthesiology residents using the disclosed system.

FIG. 2 is a chart showing the comparison between the raw number of manuscripts and modified number of manuscripts using the scholarly activity point system.

FIG. 3 is an example of a quick calculation web page for users of the disclosed system.

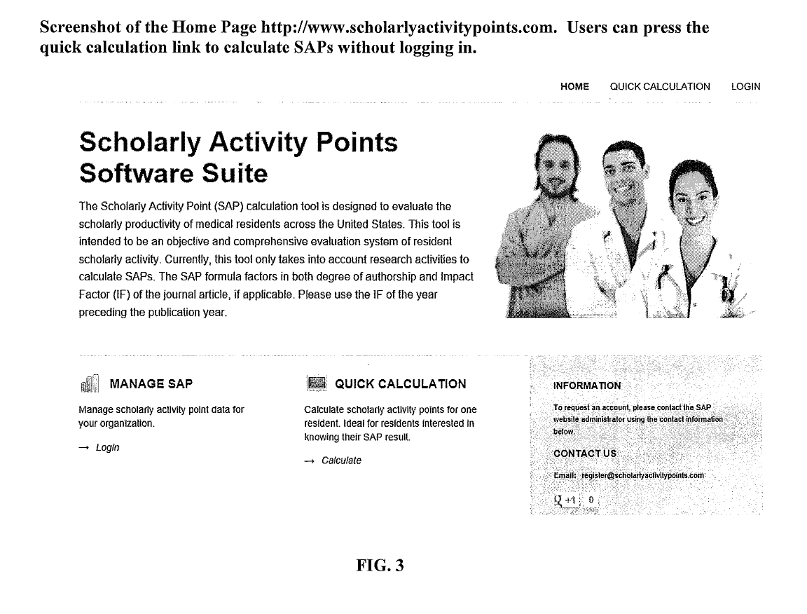

FIG. 4 is an example of a log-in page for users of the disclosed system.

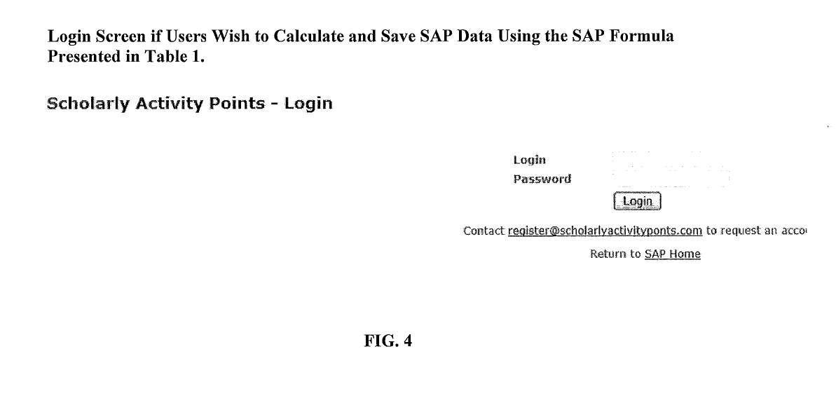

FIG. 5 is an example of a page from which an administrator can save, view, and modify scholarly activity point data.

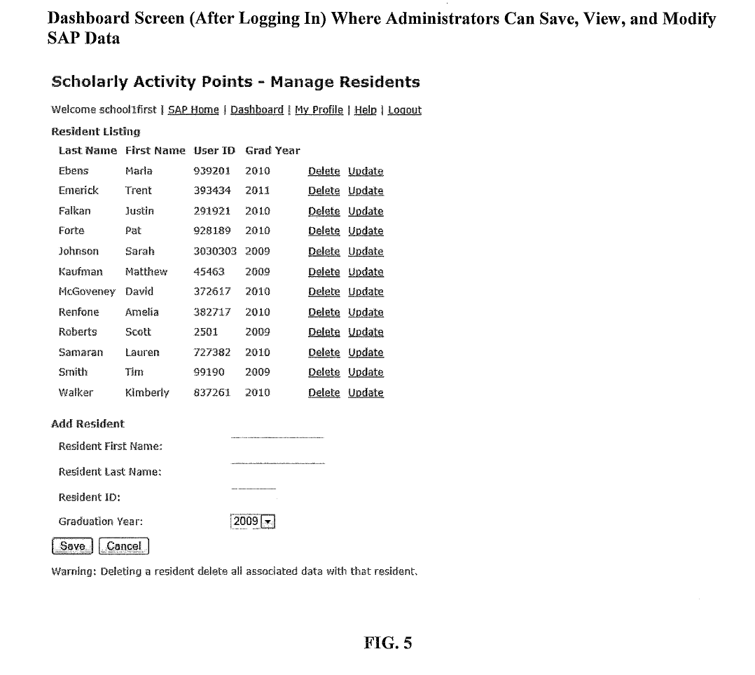

### SUMMARY OF THE INVENTION

Currently, the only known method to evaluate scholarly productivity is to simply list the scholarly activities in a résumé format. There is no objective system used to evaluate scholarly activity. For example, when looking at a list of scholarly activities, it is difficult to compare one resident's abstract presentation at a national conference to another resident's original case report published in a medical journal. The inventive SAP method more objectively evaluates scholarly productivity by assigning a specific point value to a scholarly activity based on various factors that will be described. This point value can then be used to compare scholarly activities of an individual person, or on a more global basis such as a graduating class, department, or company. The problems of a non-universal, subjective evaluation system of scholarly activities are remedied by the invention of the SAP method and website.

The invention centers on a method wherein that each scholarly activity is evaluated based on complexity and impact of an activity, and degree of involvement of a resident. Each activity is assigned a specific point value. An example of possible point values are described in Table 1. It is understood that alternative point systems or scales could be utilized without departing from the scope of the invention. Points are awarded based on local vs. national conference presentations, authorship (first author vs. a secondary author), type of research (original research project vs. case report), and awards received. SAPs can be used to compare both individuals and groups. Unlike a simple list of scholarly activities, the use of the SAP system allows for a statistical analysis of the data, such as calculation of mean SAPs or standard deviation of SAPs among a selected group. SAP data can be analyzed by a person in a supervisory role to determine effectiveness of curriculum, promotions, or departmental strengths and weaknesses. An example of a scholarly activity is an original research first author abstract presentation at a local conference. Based on the SAP formula presented in Table 1, Abstract SAPs=50×(Modifier 1.1×Modifier 1.2×Modifier 2.0×Modifier 3.0×Modifier 4.0.). The relative weight value of abstract SAPs is defined as 50. In this case, the SAPs obtained from this scholarly activity would be: Abstract SAPs=50×(0.5×1.0×1.0×1.0×1.0)=25.

### DESCRIPTION OF THE INVENTION

A computer based scoring system (SAP system) to evaluate scholarly productivity by individuals, including without limitation students, residents, and faculty has been developed. The description set forth below uses residents as an example, but it will be understood that this likewise applies to any other group of individuals creating scholarly works. The modifiers were introduced to weigh a scholarly product in each category to reflect the complexity and the significance of the product as well as the degree of involvement by the resident. The relative weight values were then added to merge the productivity in different categories into one score called SAPs. After calculating SAPs for a historical cohort of residents within a residency program, the SAP system allowed a comprehensive statistical evaluation of scholarly activities.

The traditional approach to record scholarly activities is to simply add up and list a resident's or residency program's research activities (examples in the medical literature include the following two works: 1.) Alguire P C, Anderson W A, Poland G A. Resident Research in Internal Medicine Training Programs. Ann Intern Med. 1996; 124:321-8 2.) Elliott S T, Lee E S. Surgical resident research productivity over 16 years. J Surg Res. 2009; 153:148-51). Although this approach is fairly descriptive of the individual activities, it is difficult to compare overall scholarly activities among residents, graduating classes of residents, or residency programs. With this traditional method, it is also tedious and difficult to take into account the level of resident's contribution in a project (e.g., first author vs. co-author) and the impact or significance of the scholarly product. As is the case in the previously cited works, sometimes these important factors were disregarded at the time of reporting.

In order to address the issue, the inventors have developed a novel scoring system. This comprehensive scoring system re-evaluates a scholarly product based on the degree of involvement of the researcher (authorship), complexity (category of presentation/manuscript), and impact (meeting venue or impact factor of the journal). Then the system unifies various types of scholarly activities into a single numerical value with relative value weights. Given the nature of the unified score, the analysis of the productivity trend in a particular group that is analyzed can become comprehensive and technically straightforward. These modifiers and relative weight values could be adjusted to fit the policy of a given institution. Any relative scoring system may be used. For example, an institution wishing to facilitate the number of publication may decide to assign the manuscript category more than 150 points.

Previous simplified point systems have been described in the medical literature. In 2009, a U.S. Army family medicine residency program showed that implementation of a point system can lead to increased research productivity (Seehusen D A, Asplund C A, Friedman M. A point system for resident scholarly activity. Fam Med. 2009; 41:467-9). This family medicine residency consisted of eighteen residents that previously had a requirement of completion of one research project during their residency. Their scholarly activity point system was implemented in 2007 and required the residents to obtain a minimum of 10 points to graduate. The goal of this point system was to develop enthusiasm regarding resident scholarly activity, increase the quality of research projects, and encourage more residents to present at external forums. Points were assigned for scholarly activities in various categories, such as research or teaching. Points were assigned to cover all four of Boyer's and Glassick's types of scholarship (they have described the classic definition of scholarly activity to include discovery, innovation, application, and teaching) with more points given to discovery-related scholarly activities (Boyer E L. Scholarship Reconsidered: Priorities of the Professoriate. Princeton, N.J.: Carnegie Foundation for the Advancement of Teaching, 1990. Glassick C E. Boyer's expanded definitions of scholarship, the standards for assessing scholarship, and the elusiveness of the scholarship of teaching. Acad Med. 2000 September; 75(9):877-80. PubMed PMID: 10995607).

The present SAP method and website takes the concept of the point system to a more thorough level, including weighing research activities based on a journal's impact factor and degree of authorship. The point system is more comprehensive and advocates a formula-based approach with modifiers. The formula-based point system we have described is the basis of an online calculation tool created by the inventors. The concept of assigning relative weight values to scholarly productivity has also been used in faculty incentive programs or productivity based faculty compensation programs in academic institutions (as described in 1.) Scheid D C, Hamm R M, Crawford S A. Measuring academic production. Fam Med. 2002 January; 34(1):34-44. PubMed PMID: 11838525. 2.) Weigel R J, Dracon G, Radhakrishnan R, Rho Y, Sevgen F, Dafoe D C. Incentive systems for academic productivity in a department of surgery. J Am Coll Surg. 2004; 199:300-7).

The incentive system and relative value unit approach has been well described, including the use of a theoretical merit matrix incentive system for faculty within a department of surgery, whose incentive system was based on productivity in the categories of academic rank, administrative duties, research, and teaching Unlike the present SAP system, this reported incentive system did not publish the specific point value of various activities, leaving it to the discretion of the individual institution.

There are several potential benefits of using SAPs to evaluate resident scholarly activity. First, SAPs can be used for quality control by any advisory or governing board. One traditional approach to evaluate research activity is often to require a “minimum number of scholarly activities or minimum number of publications to obtain promotion.” With the new scoring system, a minimum number of SAPs rather than a minimum number of activities would be proposed. This approach would provide incentives for researchers to pursue more challenging scholarly activities. Second, SAPs could serve as a tool to evaluate new education initiatives within a particular department. SAPs could also be helpful to modify existing curriculums to improve academic productivity. By calculating the average SAPs per person for a given group, one could determine if new research initiatives or changes in curriculum are leading to improvements. Related to medical residents, SAPs could be used as a tool to evaluate residency programs, or residents seeking faculty position or fellowship. It can be of value to applicants, faculty, program directors, and graduate medical education leadership to gain insight into a residency program. SAPs can be helpful for hiring institutions to evaluate candidates' academic productivity during previous employment or research experience.

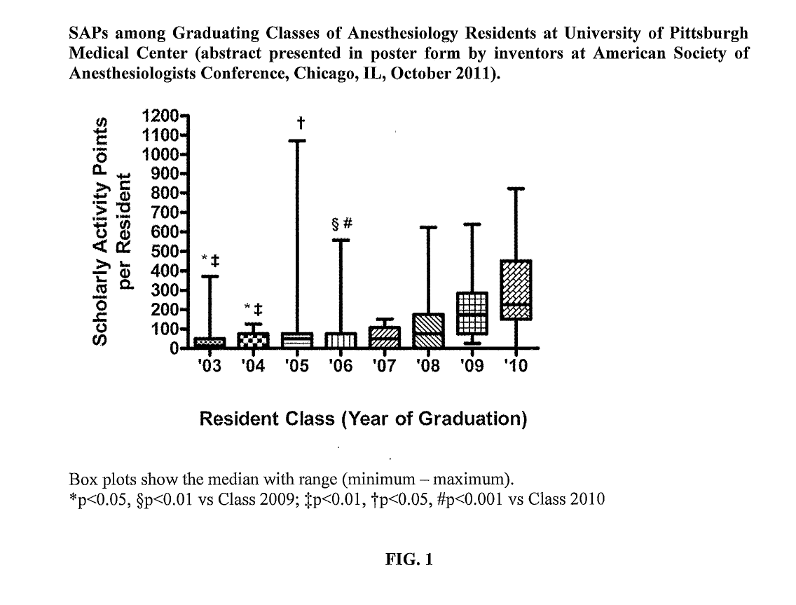

FIG. 1 describes how the calculation of SAPs can be used to compare graduating classes of anesthesiology medical residents. Direct comparison of graduating classes using the traditional method of listing scholarly activities is more subjective, and statistical analysis would not be possible.

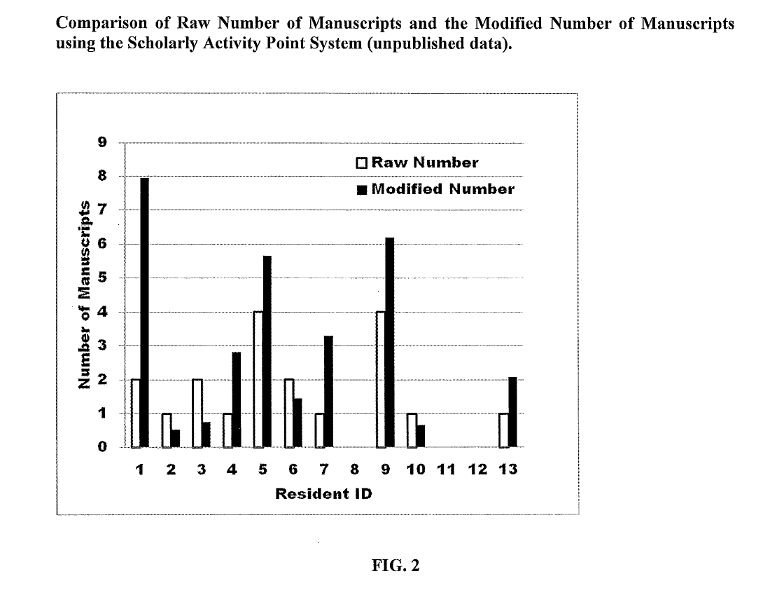

FIG. 2 describes how SAPs can provide a more objective, comprehensive evaluation of scholarly activities, in this case manuscripts submitted by medical residents to a medical journal. For example, Resident #1 authored 2 manuscripts (defined as raw number of manuscripts). However, if one calculates the modified number of manuscripts for this resident (defined as modified number), one can see that this resident was in fact more productive than Residents #2-#13 in terms of SAPs. SAPs are calculated by multiplying the modified number (the product of all the modifiers for a particular scholarly activity in Table 1 multiplied together) by the relative weight value (the designated number of points in Table 1 for a particular scholarly activity; for example, 150 points is the relative weight value for a manuscript).

TABLE 1
Scholarly Activity Points Evaluation System

Abstract SAPs = 50 × (Modifier 1.1 × Modifier 1.2 × Modifier 2.0 × Modifier 3.0 × Modifier 4.0.)
Modifier 1.1. Meeting Venue: National or International (×1.0); Local or Regional (×0.5)
Modifier 1.2. Repeated presentation in the same venue level Yes (×0.5); No (×1.0)
Modifier 2.0. Authorship: First author (×1.0); Co-author (×0.5)
Modifier 3.0. Category: Original Research (×1.0); Case Report (×0.5)
Modifier 4.0. Award: Award or Podium presentation (×1.5); Poster without award (×1.0)
Manuscript SAPs = 150 × (Modifier 1.0. × Modifier 2.0. × Modifier 3.0. × Modifier 4.0.)
Modifier 1.0. Peer-Reviewed Publication: Yes (×1.0); No (×0.5)
Modifier 2.0. Authorship: First author (×1.0); Co-author (×0.5)
Modifier 3.0. Category: Original Research (×1.0); Review Article (×0.75); Case Report (×0.5)
Modifier 4.0. Impact Factor (IF): IF > 0.5, then (×IF); 0 < IF ≦ 0.5 or no IF, then (×0.5)
Book Chapter SAPs = 50 × (Modifier 1.0. × Modifier 2.0)
Modifier 1.0. Length (pages at time of submission): ≧10 (×1.0); <10 (×0.5)
Modifier 2.0. Authorship: First author (×1.0); Co-author (×0.5)
Grant Submission SAPs = 100 × (Modifier 1.0. × Modifier 2.0. × Modifier 3.0. × Modifier 4.0.)
Modifier 1.0. Authorship: PI (principal investigator) or Co-PI (×1.0); Co-investigator (×0.5)
Modifier 2.0. Agency: Federal (×2.0); Foundation Grant (×1.5); Department Seed Grant (×1.0)
Modifier 3.0. Grant awarded: Yes (×1.5); No (×1.0)
Modifier 4.0. Life of the grant: (×Years)
Research Protocol SAPs = 75 × (Modifier 1.0. × Modifier 2.0. × Modifier 3.0.)
Modifier 1.0. Agency: IACUC (×1.0); IRB Full Board (×1.0); IRB Expedited (×0.5); IRB Exempt (×0.25)
Modifier 2.0. Authorship: PI or Co-PI (×1.0); Co-investigator (×0.5)
Other (Book Review, Letter to the Editor) SAPs = 25 × (Modifier 1.0. × Modifier 2.0.)
Modifier 1.0. Peer-Reviewed Publication: Yes (×1.0); No (×0.5)
Modifier 2.0. Authorship: First author (×1.0); Co-author (×0.5)

TABLE 2
Example Scholarly Activity Data Displayed Using the Traditional and SAP
Methods. The traditional method (shaded in grey) simply lists the total number of each
type of scholarly activities.

| | Graduation Year of Residency Class | | | | | | | |
|---|---|---|---|---|---|---|---|---|
| | (Number of Residents per Class) | | | | | | | |
| | 2003 | 2004 | 2005 | 2006 | 2007 | 2008 | 2009 | 2010 |
| Categories (Total Numbers) | (10) | (11) | (19) | (14) | (9) | (15) | (15) | (13) |
| Abstracts | 6 | 3 | 15 | 6 | 8 | 15 | 33 | 49 |
| Local/Regional | 3 | 2 | 6 | 2 | 4 | 4 | 15 | 28 |
| National/International | 3 | 1 | 9 | 4 | 4 | 11 | 18 | 21 |
| Manuscripts (case reports) | 1 | 3 | 5 | 0 | 0 | 0 | 1 | 3 |
| Manuscripts (original articles) | 1 | 0 | 2 | 3 | 0 | 4 | 4 | 9 |
| Grants | 1 | 0 | 1 | 0 | 0 | 0 | 0 | 2 |
| Book Chapters | 0 | 1 | 3 | 3 | 3 | 7 | 9 | 6 |
| Books | 0 | 0 | 0 | 0 | 0 | 1 | 0 | 0 |
| Institutional Review Boards | 0 | 0 | 0 | 0 | 0 | 1 | 0 | 0 |
| Others | D | D | 0 | 0 | 1 | 1 | 0 | 2 |
| Total SAPs | 521.0 | 400.0 | 1896.6 | 832.6 | 540.0 | 2238.3 | 2915.2 | 4000.2 |
| Average SAPs per Resident | 52.1 | 36.4 | 99.8 | 59.5 | 60.0 | 149.2 | 194.3 | 307.7 |
| Standard Deviation | 113.9 | 47.9 | 238.3 | 147.0 | 57.0 | 185.9 | 156.0 | 230.5 |
| Median SAPs | 12.5 | 0.0 | 50.0 | 0.0 | 50.0 | 75.0 | 175.0 | 225.0 |
| Maximum SAPs | 371.0 | 125.0 | 1071.6 | 557.6 | 150.0 | 623.8 | 639.7 | 822.4 |
| Minimum SAPs | 0.0 | 0.0 | 0.0 | 0.0 | 0.0 | 0.0 | 25.0 | 0.0 |
| % of Residents with Zero SAP | 50.0 (5) | 54.5 (6) | 26.3 (5) | 64.3 (9) | 33.3 (3) | 26.7 (4) | 0.0 (0) | 7.7 (1) |
| (number of residents) | | | | | | | | |

The invention claimed is:

1. A computer-implemented method of evaluating scholarly activities of individuals within a group, the method comprising:
entering the scholarly activities performed by the individuals into the system;
assigning point values to one or more scholarly activities performed by the individuals;
subjecting the point values to one or more modifiers, the modifiers being based upon the extent of work performed by the individual on each scholarly activity performed by the individual;
dynamically weighing the scholarly activities of the individuals based upon the scholarly activities and modifiers; and
calculating a point total for each individual based on the weighed scholarly activities.
